(19) United States
(12) Patent Application Publication
(10) Pub. No.: US 2018/0300100 A1
(43) Pub. Date: Oct. 18, 2018

(54) AUDIO EFFECTS BASED ON SOCIAL NETWORKING DATA

(71) Applicant: Facebook, Inc., Menlo Park, CA (US)

(72) Inventors: Scott Snibbe, San Francisco, CA (US); William J. Littlejohn, Hillsborough, CA (US); Dwayne B. Mercredi, Kirkland, WA (US)

(21) Appl. No.: 15/489,715

(22) Filed: Apr. 17, 2017

(51) Int. Cl. G06F 3/16; H04L 29/08; H04N 21/233; H04N 21/81; H04N 21/258

(52) U.S. Cl. CPC G06F 3/165; H04L 67/306; H04N 21/25841; H04N 21/8106; H04N 21/233

(57) ABSTRACT

Techniques are described for determining what effects to apply to audiovisual content. An effect that is applied to audiovisual content may be an audio effect. When applied to an audiovisual content, an audio effect modifies an audio portion of the audiovisual content. The modified audiovisual content resulting from applying the effects to the audiovisual content may then be output via a user's device. For example, the modified audiovisual content may be output via an application executed by the user's device (e.g., a camera application) that is configured to output audiovisual content. An effect to be applied to audiovisual content may be determined based on various criteria such as, without limitation, attributes of the audiovisual content (e.g., content included in the audiovisual content), social networking data stored by a social networking system, information related to targets of the modified audiovisual content and devices used to consume the modified audiovisual content, and the like, or any combination thereof.

### BACKGROUND

A social networking system enables its users to interact with and share information with each other through various interfaces provided by the social networking system. In order to use a social networking system, a user typically has to register with the social networking system. As a result of the registration, the social networking system may create and store information about the user, often referred to as a user profile. The user profile may include the user's identification information, background information, employment information, demographic information, communication channel information, personal interests, or other suitable information. Information stored by the social networking system for a user can be updated based on the user's interactions with the social networking system and other users of the social networking system.

The social networking system may also store information related to the user's interactions and relationships with other entities (e.g., users, groups, posts, pages, events, photos, audiovisual content (e.g., videos), apps, etc.) in the social networking system. The social networking system may store the information in a social graph. For example, a social graph may include nodes representing individuals, groups, entities, organizations, or the like. And the edges between the nodes may represent one or more specific types of interdependencies or interactions between the entities. The social networking system may use this stored information to provide various services (e.g., wall posts, photo sharing, event organization, messaging, games, advertisements, or the like) to its users to facilitate social interaction between the users using the social networking system. A social networking system is always looking for new services to provide its users to enhance the users' experience within the social networking system.

### SUMMARY

The present disclosure describes techniques for determining what effects to apply to audiovisual content. The effects can cause a modification in the audiovisual content, which the result can be output via a user's device. For example, the modified audiovisual content may be output via an application executing by the user's device (e.g., a camera application) that is configured to output audiovisual content.

In certain embodiments, an effect that is applied to the audiovisual content may be an audio effect, a video effect, or a combination thereof. When applied to the audiovisual content, an audio effect modifies the audio portion of the audiovisual content.

As indicated above, audio effects may be applied to audiovisual content. An audio effect may be applied to audiovisual content by deleting an audio portion of the audiovisual content, changing a characteristic of an audio portion of the audiovisual content (e.g., changing the pitch), adding a new audio portion to the audiovisual content, or any combination thereof. Various different types of audio effects may be applied such as, without limitation, ambient audio effects (e.g., background sound), triggered audio effects (e.g., audio effects that are triggered based on certain events happening in the audiovisual content), audio effects created using digital signal processor (DSP) techniques (e.g., modifications to one or more qualities of sound, such as the pitch of the audio, echo effect, etc.), synthetic audio effects that synthesize music or sounds in real time based on one or more algorithms, spatialized audio effects (e.g., audio effects connected to a different location in the real world or a virtual object to give the impression that audio is coming from a specific point in space), or any combination thereof.

In certain embodiments, an audio engine is provided that is adapted to determine one or more audio effects to be applied to audiovisual content. The audio engine may use various criteria to determine the one or more audio effects to be applied to the audiovisual content. For example, the audio engine may use information stored by a social networking system.

A social networking system may store information about its users (e.g., user profiles) and also store information related to the users' interactions and relationships with other entities (e.g., users, groups, posts, pages, events, photos, audiovisual content (e.g., videos), apps, etc.) in the social networking system. For example, the social networking system may store the information in a social graph. A social graph may, for example, include nodes representing individuals, groups, entities, organizations, or the like. The social graph may further include edges between the nodes, representing one or more specific types of interdependencies or interactions between the entities. In certain embodiments, the audio engine may use the information stored by the social networking system to determine the one or more audio effects to be applied to the audiovisual content.

For one illustrative example, the audio engine may determine that particular audiovisual content is intended for a targeted user. The targeted user can be identified based on profile information for a content creator (e.g., a user that is going to receive an audio effect from the audio effect or a user that is going to cause the audio engine to modify audiovisual content based on an audio effect). In particular, the audio engine may determine that today is the content creator's wedding anniversary. In addition, based on the profile information of the content creator, the audio engine may identify profile information of the targeted user. The profile information of the targeted user can include a special song that was played when the content creator was married to the targeted user. The audio engine may then determine to add that special song as an audio effect to the audiovisual content such that when the modified audiovisual content is output, the special song is also output as background music.

In certain embodiments, the audio engine may also determine the one or more effects to be applied to the audiovisual content based on attributes of audiovisual content received from a device. These attributes may include, for example, content of the received audiovisual content, such as events occurring in the received audiovisual content, people or places occurring in the received audiovisual content, and the like. Another attribute of the audiovisual content may be the one or more targeted users of the audiovisual content. The targeted user can be another user of the social networking system who is an intended recipient/viewer of the audiovisual content.

In certain embodiments, the audio engine may also determine the one or more effects to be added to audiovisual content based on information available from one or more sensors on a user's device, such as the user's location based on geographical information available about the user's device, a temperature reading indicated by a temperature sensor on the user's device, information from an accelerometer on the user's device indicating whether the user is stationary or moving, including speed of the motion, or the like.

Provided is a method performed by a computing system for sending an audio effect to a device for modifying audiovisual content on the device. The method can include identifying a user of a social networking system. In some embodiments, the user is associated with the device. In other embodiments, the user is not associated with the device. In such embodiments, the user can be a first user, where a second user is associated with the device. For example, the first user can be a friend of the second user based on a social graph of the social networking system.

The method can further include accessing data stored by the social networking system. In some embodiments, the data can be associated with the user. In some embodiments, the data stored by the social networking system can include data describing the user or data related to connections between the users of the social networking system. In such embodiments, the users of the social networking system can include the user.

The method can further include determining an audio effect based on the data stored by the social networking system. In some embodiments, the audio effect can indicate how to modify an audio portion of audiovisual content. In such embodiments, the audio effect can include an ambient sound to be added to the audiovisual content, an indication of an event to cause an audio portion to be added to the audiovisual content, one or more algorithms to synthesize sound, a location to be used to balance sound for spatialized audio, or one or more parameters for applying one or more digital signal processor (DSP) techniques to the audiovisual content.

The method can further include sending: the audio effect to a device for modifying audiovisual content on the device; or (2) modified audiovisual content to the device, where the modified audiovisual content comprises an audio portion modified based on the audio effect. In some embodiments, modifying the audiovisual content can include merging the audio effect with the audiovisual content. In some embodiments, the modified audiovisual content can be output by the device. In such embodiments, an audio portion of the modified audiovisual content can be output using an audio output subsystem of the device and a video portion of the modified audiovisual content can be output using a video output subsystem of the device.

The method can further include receiving audiovisual content associated with the user and determining an attribute of the received audiovisual content. In some embodiments, determining the audio effect can be further based on the attribute. In such embodiments, the user can be identified based on the received audiovisual content. In some embodiments, the user can be identified by detecting a presence of the user in the received audiovisual content.

The method can further include receiving sensor data from one or more sensors of the device, where determining the audio effect is further based on the sensor data. In some embodiments, the sensor data can include data indicative of a physical location of the device. In other embodiments, the sensor data can include accelerometer data generated by an accelerometer of the device or a temperature reading sensed by a temperature sensor on the device

The terms and expressions that have been employed in this disclosure are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although certain concepts and techniques have been specifically disclosed, modification and variation of these concepts and techniques may be resorted to by those skilled in the art, and that such modifications and variations are considered to be within the scope of the systems and methods as defined by this disclosure.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures:

FIG. 1 is a simplified flowchart depicting processing performed by a device and an audio engine according to certain embodiments;

FIG. 2 is a simplified block diagram of system for determining one or more audio effects to audiovisual content according to certain embodiments;

FIG. 3 is a simplified flowchart depicting processing performed by an audio engine according to certain embodiments;

FIG. 4 is a simplified block diagram of a distributed environment 400 that may implement an exemplary embodiment; and

FIG. 5 illustrates an example of a block diagram of a computing system.

### DETAILED DESCRIPTION

In the following description, for the purposes of explanation, specific details are set forth in order to provide a thorough understanding of examples of the disclosure. However, it will be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may be shown without necessary detail in order to avoid obscuring the examples. The figures and description are not intended to be restrictive.

The ensuing description provides examples only, and is not intended to limit the scope, applicability, or configuration of the disclosure. Rather, the ensuing description of the examples will provide those skilled in the art with an enabling description for implementing an example. It should be understood that various changes may be made in the function and arrangement of elements without departing from the spirit and scope of the disclosure as set forth in the appended claims.

Also, it is noted that individual examples may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable storage medium or computer-readable storage medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some examples, the systems may be configured as a distributed system where one or more components of the system are distributed across one or more networks such as in a cloud computing system.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

According to certain embodiments, the present disclosure describes techniques for determining what effects to apply to audiovisual content. The effects can cause a modification in the audiovisual content, which the result can be output via a user's device. For example, the modified audiovisual content may be output via an application executing by the user's device (e.g., a camera application) that is configured to output audiovisual content.

In certain embodiments, an effect that is applied to the audiovisual content may be an audio effect, a video effect, or any combination thereof. When applied to the audiovisual content, an audio effect can modify the audio portion of the audiovisual content. In particular, an audio effect may modify audiovisual content by deleting an audio portion of the audiovisual content, changing a characteristic of an audio portion of the audiovisual content (e.g., changing the pitch), adding a new audio portion to the audiovisual content, or any combination thereof. Various different types of audio effects may be applied such as, without limitation, ambient audio effects (e.g., background sound), triggered audio effects (e.g., audio effects that are triggered based on certain events happening in the audiovisual content), audio effects created using digital signal processor (DSP) techniques (e.g., modifications to one or more qualities of sound, such as the pitch of the audio, echo effect, etc.), synthetic audio effects that synthesize music or sounds in real time based on one or more algorithms, spatialized audio effects (e.g., audio effects connected to a different location in the real world or a virtual object to give the impression that audio is coming from a specific point in space), or any combination thereof. The ambient audio effects can be pre-recorded ambient audio tracks (single play or looping). The spatialized audio effects (sometimes referred to as 360 audio effects) can give the impression that audio is coming from the specific point by balancing sound going to a user's ears. The spatialized audio effects can be useful for directing the user to look at something located behind them, and for a heightened sense of realism.

In certain embodiments, an audio engine is provided that is adapted to determine one or more audio effects to be applied to audiovisual content. The audio engine may use various criteria to determine the one or more audio effects to be applied to the audiovisual content. For example, the audio engine may use information stored by a social networking system.

A social networking system may store information about its users (e.g., user profiles) and also store information related to the users' interactions and relationships with other entities (e.g., users, groups, posts, pages, events, photos, audiovisual content (e.g., videos), apps, etc.) in the social networking system. For example, the social networking system may store the information in a social graph. A social graph may, for example, include nodes representing individuals, groups, entities, organizations, or the like. The social graph may further include edges between the nodes, representing one or more specific types of interdependencies or interactions between the entities. In certain embodiments, the audio engine may use the information stored by the social networking system to determine the one or more audio effects to be applied to the audiovisual content.

For one illustrative example, the audio engine may identify a targeted user for particular audiovisual content. For example, the targeted user can be a user that will be receiving a result of applying the audio effect to the particular audiovisual content (e.g., modified audiovisual content). In such an example, the audio effect to be used can be determined based on social networking data of the targeted user, a content creator (where the content creator is a user that will receive the audio effect for modifying audiovisual content or a user that will direct the audio engine to send modified audiovisual content to the targeted user), a user tagged in the particular audiovisual content (e.g., the content creator can associated a user with the particular audiovisual content even if the tagged user does not receive the particular audiovisual content), or any combination thereof.

Based on the social networking data, the audio engine may determine that today is the content creator's wedding anniversary. Further, based on the information stored by the social networking system, the audio engine may determine that either the content creator or the wife of the content creator (i.e., the targeted user) has a special song that was played when the content creator was married. The audio engine may then determine to add that special song as an audio effect to the audiovisual content such that when the modified audiovisual content is output, the special song is also output as background music.

In certain embodiments, the audio engine may also determine the one or more effects to be applied to the audiovisual content based on attributes of an audiovisual content received from a device. These attributes may include, for example, content of the received audiovisual content, such as events occurring in the received audiovisual content, people or places occurring in the received audiovisual content, and the like. Another attribute of the audiovisual content may be the one or more targeted users of the audiovisual content.

In certain embodiments, the audio engine may also determine the one or more effects to be added to audiovisual content based on information available from one or more sensors on a user's device, such as the user's location based on geographical information available about the user's device, a temperature reading indicated by a temperature sensor on the user's device, information from an accelerometer on the user's device indicating whether the user is stationary or moving, including speed of the motion, or the like.

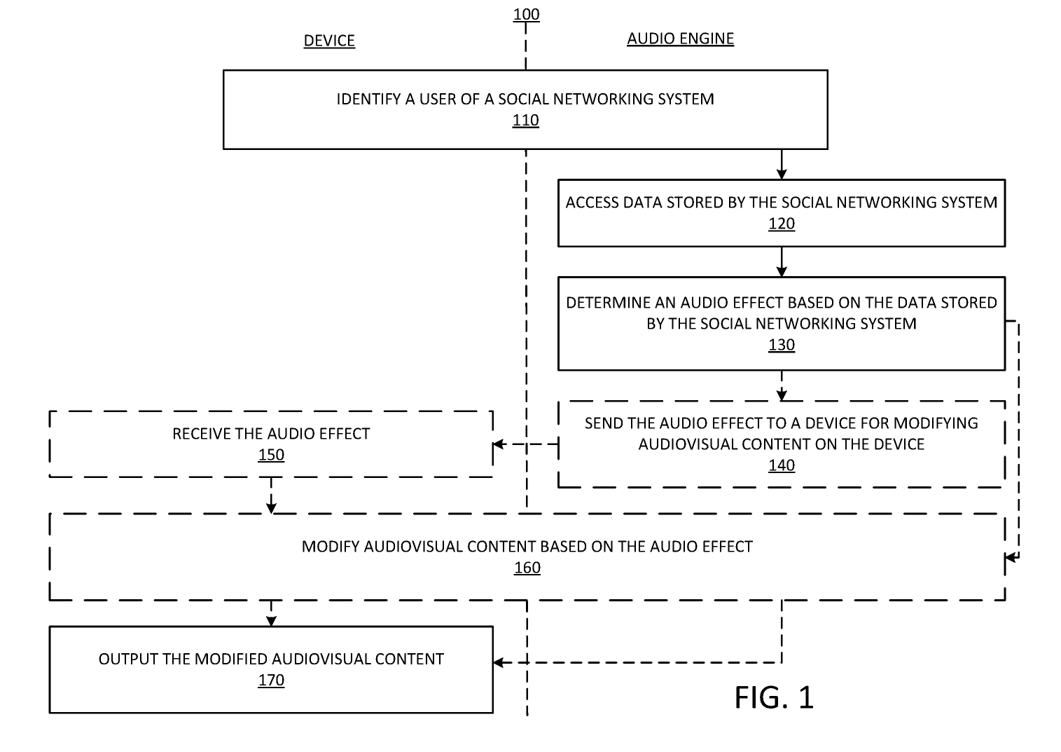

FIG. 1 is a simplified flowchart depicting processing performed by a device and an audio engine according to certain embodiments. The processing depicted in FIG. 1 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 1 and described below is intended to be illustrative and non-limiting. The particular series of processing steps depicted in FIG. 1 is not intended to be limiting. Steps on the left side of the dotted line are performed by the device, steps on the right side of the dotted line are performed by the audio engine, and steps on both sides of the dotted line can be performed by either the device or the audio engine.

At 110, a user of a social networking system can be identified. The user can be identified by either the device or the audio engine. In some embodiments, the user can be a content creator, who can be associated with a device that is generating modified audiovisual content (e.g., the modified audiovisual content can be created on the device or on the social networking system). In other embodiments, the user can be a targeted user, who can be an intended recipient of modified audiovisual content. The intended recipient can be someone that a user of the device intends to send the modified audiovisual content to. In other embodiments, the user can be a user related to the content creator (e.g., a user tagged in audiovisual content or a user identified by the audio engine to be an intended recipient of modified audiovisual content).

While it should be recognized that there are many ways that the user can be identified, a few will be described below. For example, the device can identify a user associated with a social networking application executing on the device, where the social networking application is associated with the social networking system. In such an example, the audio engine can receive a message from the device, where the message includes an identification of the user.

For another example, the audio engine can identify the user based on users of the social networking system. For example, the audio engine can request all users of the social networking system that meet one or more criteria. In such an example, a user returned by the social networking system based on the one or more criteria can be established as the user.

For another example, the audio engine can receive audiovisual content from the device (or another device or system). The audio engine can then identify the user based on the received audiovisual content (e.g., content recognition of the received audiovisual content).

At 120, after the user is identified, data stored by the social networking system (sometimes referred to as social networking data) can be accessed. The social networking data can include various types of data including but not limited to user-profile data, social-graph data, or other data stored by the social networking system (as will be described more below). In some embodiments, the user-profile data (or portions thereof) may be included in the social-graph data.

The user-profile data can include information about or related to a user of the social networking system. A user may be an individual (human user), an entity (e.g., an enterprise, a business, or a third-party application), or a group (e.g., of individuals or entities) that use the social networking system. A user may use the social networking system to interact, communicate, or share information with other users or entities of the social networking system. The user-profile data for a user may include information such as the user's name, profile picture, contact information, birth date information, sex information, marital status information, family status information, employment information, education background information, user's preferences, interests, or other demographic information. The social networking system can update this information based on the user's interactions using the social networking system.

As an example and not by way of limitation, the user-profile data may include proper names (first, middle and last of a person, a trade name or company name of a business entity, etc.), nicknames, biographic, demographic, a user's sex, current city of residence, birthday, hometown, relationship status, wedding anniversary, song played at wedding, political views, what the user is looking for or how the user is using the social networking system (e.g., looking for friendships, relationships, dating, networking, etc.), various activities the user participates in or enjoys, various interests of the user, various media favorites of the user (e.g., music, television show, book, quotation), contact information of the user (e.g., email addresses, phone numbers, residential address, work address, or other suitable contact information), educational history of the user, employment history of the user, and other types of descriptive information of the user.

The social-graph data can be related to a social graph stored by the social networking system. In certain implementations, a social graph may include multiple nodes with the nodes representing users and other entities within the social networking system. The social graph may also include edges connecting the nodes. The nodes and edges may each be stored as data objects by the social networking system.

In particular embodiments, a user node within the social graph may correspond to a user of the social networking system. For a node representing a particular user, information related to the particular user may be associated with the node by the social networking system.

In certain embodiments, a pair of nodes in the social graph may be connected by one or more edges. An edge connecting a pair of nodes may represent a relationship between the pair of nodes. In particular embodiments, an edge may comprise or represent a data object (or an attribute) corresponding to the relationship between a pair of nodes. As an example and not by way of limitation, a first user may indicate that a second user is a “friend” of the first user. In response to this indication, the social networking system may transmit a “friend request” to the second user. If the second user confirms the “friend request,” the social networking system may create an edge connecting the first user's user node and the second user's user node in a social graph, and store the edge as social-graph data in one or more of data stores. As an example and not by way of limitation, an edge may represent a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

In particular embodiments, an edge type may include one or more edge sub-types that add more detail or metadata describing the specific type of connection between corresponding pairs of nodes. An edge may be one of a plurality of edge types based at least in part on the types of nodes that the edge connects in the social graph. As an example and not by way of limitation, a web application for NETFLIX may result in an edge type that signifies “movies I want to see.” In such embodiments in which edges have or are assigned associated edge types, the edge itself may store, or be stored with, data that defines a type of connection between the pair of nodes the edge connects, such as, for example, data describing the types of the nodes the edge connects (e.g., user, hub, category or classification of hub).

In particular embodiments, each edge may simply define or represent a connection between nodes regardless of the types of nodes the edge connects. The edge itself may store, or be stored with, identifiers of the nodes the edge connects but may not store, or be stored with, data that describes a type of connection between the pair of nodes the edge connects. Furthermore, in any of these or other embodiments, data that may indicate the type of connection or relationship between nodes connected by an edge may be stored with the nodes themselves. In particular embodiments, the edges, as well as attributes (e.g., edge type and node identifiers corresponding to the nodes connected by the edge), metadata, or other information defining, characterizing, or related to the edges, may be stored (e.g., as data objects) in a social-graph database.

At 130, an audio effect can be determined based on the data stored by the social networking system. In some embodiments, the audio engine can include logic for determining when a particular audio effect is relevant to a particular event identified from the data stored by the social networking system. For example, the audio engine can identify audio effects that are for birthdays, such that the audio engine can determine an audio effect related to birthdays when the data indicates a birthday. In other embodiments, audio effects can include metadata that indicates subjects that the audio effects are related to. For examples, an audio effect can include one or more tags that describe when the audio effect would be relevant. In other embodiments, the audio engine can execute an audio effect to determine whether the audio effect should be determined based on the data stored by the social networking system. In some embodiments, the audio engine can have access to a pool of audio effects that may be received from one or more sources. In such embodiments, the audio engine can determine the audio effect from the pool of audio effects.

An audio effect may include an ambient sound to be added to audiovisual content, an indication of an event to cause an audio effect to be applied to audiovisual content, one or more parameters for applying one or more digital signal processor (DSP) techniques to audiovisual content, one or more algorithms to synthesize sound, a location to be used to balance sound for spatialized audio, or any combination thereof.

In some embodiments, determining the audio effect can be further based on data obtained by the device (sometimes referred to as sensor inputs). For example, the sensor inputs can include a physical location of the device, a current temperature of an environment where the device is located, accelerometer information, or other data sensed by one or more sensors of the device.

After 130, the flowchart can either go to 140 or 150, depending on whether the device or the audio engine is modifying the audiovisual content. At 140, the audio effect can be sent to the device for output by the device. In some embodiments, the audio effect can include logic for applying the audio effect to audiovisual content. The audio effect can also include logic for determining when to apply the audio effect. The audio effect can also include audio to be used when applying the audio effect. And at 150, the audio effect can be received by the device.

At 160, audiovisual content can be modified based on the audio effect. For example, the audio effect may modify the audiovisual content by deleting an audio portion of the audiovisual content, changing a characteristic of an audio portion of the audiovisual content (e.g., changing the pitch), adding a new audio portion to the audiovisual content, or any combination thereof. Modifying the audiovisual content can generate modified audiovisual content. In some embodiments, modifying the audiovisual content comprises merging the audio effect with the audiovisual content. In some examples, audio effects can be layered such that multiple audio effects are applied to the audiovisual content. For example, a first layer (e.g., a first audio effect) can be applied to the audiovisual content. In such an example, a second layer (e.g., a second audio effect) can also be applied to the audiovisual content, where the first layer is applied on top of the second layer to change how the audiovisual content sounds. In some examples, the modifications can occur on the device. In other examples, the modification can occur by the audio engine.

At 170, the modified audiovisual content can be output by the device. In some embodiments, an audio portion of the modified audiovisual content can be output using an audio output subsystem of the device and a video portion of the modified audiovisual content can be output using a video output subsystem of the device.

While FIG. 1 describes certain steps being performed by certain devices or systems in a certain order, it should be recognized that the steps could be performed by different devices or systems and/or in a different order.

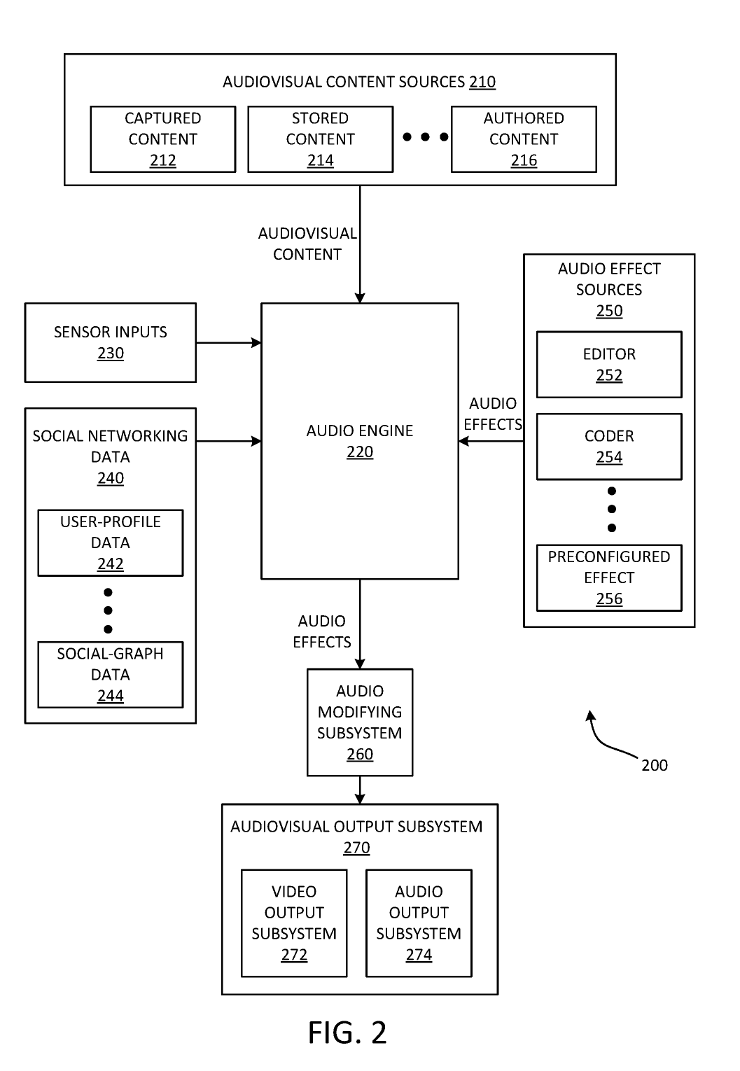

FIG. 2 is a simplified block diagram of system 200 for determining one or more audio effects to audiovisual content according to certain embodiments. System 200 depicted in FIG. 2 is merely an example and is not intended to unduly limit the scope of inventive embodiments recited in the claims. One of ordinary skill in the art would recognize many possible variations, alternatives, and modifications. For example, in some implementations, system 200 may have more or fewer systems than those shown in FIG. 2, may combine two or more systems, or may have a different configuration or arrangement of systems.

As depicted in FIG. 2, system 200 includes audio engine 220 that is adapted to receive audiovisual content as input, determine one or more audio effects to apply to audiovisual content on a user's device based on various criteria, send the one more audio effects to the user's device such that the one or more effects are applied to the audiovisual content to be output by the user's device.

The received audiovisual content can be from various audiovisual content sources 210. For example, the received audiovisual content can be from an audiovisual information capture subsystem of the user's device or a remote system (e.g., captured content 212). For example, the audiovisual information capture subsystem can capture audio and/or video information in real time. In some embodiments, audiovisual information capture subsystem may include one or more cameras for capturing images or video, one or more microphones for capturing audio, or the like. The audiovisual content can also be an output from an application (either executing on the user's device or a remote system).

In certain embodiments, the received audiovisual content may include authored content 216, which may include, for example, a video clip, an audio clip, etc. authored by a user. Authored content 216 may be authored using various available authoring applications (e.g., audio and video editing applications). Authored content 216 may include original content, licensed content, or any combination thereof.

In certain embodiments, the received audiovisual content may include stored audiovisual content 214 accessed from a stored location. The stored location may be on a user device from a storage location within a social networking system or a remote location.

Audio engine 220 is configured to determine one or more audio effects to be applied to audiovisual content on a user's device. As indicated above, audio engine 220 may use various different criteria for determining the one or more audio effects. In some embodiments, determining the one or more audio effects can be based on sensor inputs 230, social networking data 240, the received audiovisual content (e.g., certain events happening in the received audiovisual content or an indication of a user associated with the received audiovisual content), or any combination thereof.

Sensor inputs 230 can be current information that is obtained by one or more sensors on the user's device. Examples of sensor inputs 230 include a current location of the user's device, a current temperature of an environment where the user's device is located, accelerometer information, or the like.

Social networking data 240 represents data stored by a social networking system. Social networking data 240 can include various types of data including but not limited to user-profile data 242, social-graph data 244, or other data stored by the social networking system as described above. In some embodiments, user-profile data 242 (or portions thereof) may be included in social-graph data 244. For an illustrative example, social networking data 240 can indicate that the user has a birthday today. Based on that information, a happy birthday audio effect can be determined to be presented by a device of the user.

Social-graph data 244 can be related to a social graph stored by a social networking system. In certain implementations, a social graph may include multiple nodes with the nodes representing users and other entities within the social networking system as described above. The social graph may also include edges connecting the nodes as described above.

In some embodiments, audio engine 220 can include logic for determining when a particular audio effect is relevant to a particular event identified from the social networking data 240. For example, audio engine 220 can identify audio effects that are for birthdays, such that audio engine 220 can determine an audio effect related to birthdays when the social networking data 240 indicates a birthday. In other embodiments, audio effects can include metadata that indicates subjects that the audio effects are related to. For examples, an audio effect can include one or more tags that describe when the audio effect would be relevant. In other embodiments, audio engine 220 can execute an audio effect to determine whether the audio effect should be determined based on the social networking data 240. In some embodiments, audio engine 220 can have access to a pool of audio effects that may be received from audio effect sources 250. In such embodiments, audio engine 220 can determine the audio effect from the pool of audio effects.

In some embodiments, the one or more audio effects can be determined from one or more audio effect sources 250. The audio effect sources can include an editor 252, a coder 254, a preconfigured effect data store 256, or any combination thereof. The editor 252 can provide a graphical user interface for a user to create an effect (e.g., an audio effect). The coder 254 can provide a textual user interface for a user to create the effect. The preconfigured effect data store 256 can be a database with entire effects stored thereon.

After audio engine 220 has determined one or more audio effects to be applied to audiovisual content on the user's device, audio engine 220 is configured to send the one or more audio effects to the user's device. The user's device, using audio modifying subsystem 260, can apply the determined one or more audio effects to audiovisual content on the user's device to generate modified audiovisual content. For example, the one or more audio effects can modify an audio portion of the audiovisual content on the user's device. Modifying the sound portion can include deleting an audio portion of the audiovisual content on the user's device, changing a characteristic of an audio portion of the audiovisual content on the user's device (e.g., changing the pitch), adding a new audio portion to the audiovisual content on the user's device, or combinations thereof.

In certain embodiments, the user's device, using audiovisual output subsystem 270, can output the modified audiovisual content. The video portion of the modified audiovisual content may be output via video output subsystem 272 of audiovisual output subsystem 270. The audio portion of the modified audiovisual content, including the modified audio, may be output using audio output subsystem 274 (e.g., speakers) of audiovisual output subsystem 270.

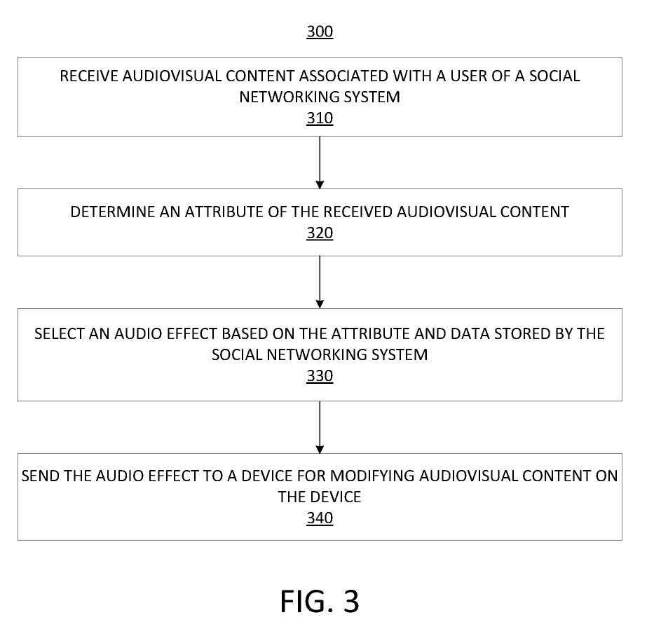

FIG. 3 is a simplified flowchart depicting processing performed by an audio engine according to certain embodiments. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 3 and described below is intended to be illustrative and non-limiting. The particular series of processing steps depicted in FIG. 3 is not intended to be limiting.

At 310, audiovisual content may be received by an audio engine (e.g., audio engine 220 depicted in FIG. 2. As previously discussed with respect to FIG. 2, the audiovisual content may be received from various sources. The audiovisual content can include a visual portion (e.g., one or more frames) and/or an auditory portion (e.g., a length of time of audio).

At 320, one or more attributes of the received audiovisual content may be determined. For example, as described above, an attribute can include content of the received audiovisual content itself, such as events occurring in the received audiovisual content, people or places occurring in the received audiovisual content, and the like. Another attribute of the audiovisual content may be the one or more targeted users of the audiovisual content.

In some embodiments, determining the one or more attributes can include identifying users based on the received audiovisual content. For example, a user is identified within the audiovisual content itself (e.g., via face recognition, location determination, and other techniques for tagging users in content). For another example, the received audiovisual content can include (or be sent separately from the received audiovisual content) data that indicates the user. Specifically, content, when captured or uploaded is associated with a user identifier (UID) of a user of the social networking system. For another example, rather than receiving the audiovisual content, the audio engine can just receive the data that uniquely identifies the user (e.g., IUD).

At 330, the audio engine selects one or more audio effects based on the one or more attributes determined in 320 and based on various criteria including social networking system data stored by a social networking system and/or sensor data received from the user's device. An audio effect may include an ambient sound to be added to audiovisual content, an indication of an event to cause an audio effect to be applied to audiovisual content, one or more parameters for applying one or more digital signal processor (DSP) techniques to audiovisual content, one or more algorithms to synthesize sound, a location to be used to balance sound for spatialized audio, or any combination thereof.

The social networking data can include data obtained from a social networking system. Examples of the data obtained from the social networking system can include user-profile data, connections between users, and other information known by the social networking system. In some embodiments, the social networking data can be related to a user associated with the user's device. For example, the user can be the one that is going to be sharing audiovisual content with the one or more audio effects on the user's device. The social networking data can also be related to a user that is to receive audiovisual content with the one or more audio effects. For example, a friend of the user can have a birthday today. In the example, one or more audio effects can be determined based on the fact that it is the friend's birthday today. Accordingly, the one or more audio effects would be determined based on the friend, rather than the user.

The sensor inputs can include data obtained by the user's device. For example, the sensor inputs can include a physical location of the user's device, a current temperature of an environment where the user's device is located, accelerometer information, or other data sensed by one or more sensors of the user's device.

In some embodiments, determining the one or more audio effects can include identifying user-profile data stored by the social networking system for a user. The user-profile data can include data describing the user or data related to connections between users.

Examples of audio effects determined based on the social networking data include: the “happy birthday” song to be played based on data indicating that it is the user's birthday; a special anniversary song to be played based on data indicating that it is the user's anniversary and that the end user's anniversary song is the special anniversary song; audio effects reminiscent of when the user was a young adult to be added based on data indicating an age of the end user; etc.

At 340, the one or more audio effects can be sent to the user's device for output by the user's device. For example, audiovisual content on the user's device can be modified by applying the one or more audio effects to generate modified audiovisual content. In some embodiments, being applied to the audiovisual content can indicate that the one or more audio effects include additional audio that is added along with audio of the audiovisual content on the user's device. In other embodiments, being applied to the audiovisual content can indicate that the one or more audio effects include changes to the audio of the audiovisual content on the user's device (e.g., pitch change, muting, volume change, or the like). In some embodiments, modifying the audiovisual content comprises merging the audio effect with the audiovisual content on the user's device. The merging of the effect can occur either on the social networking system (where the audiovisual content is sent to the social networking system) or by the user's device (e.g., where an audio effect or a reference to the audio effect is selected by the social networking system and sent to the user's device). The audiovisual content with the one or more audio effects can be output by the user's device. In some embodiments, an audio portion of the modified audiovisual content can be output using an audio output subsystem of the device and a video portion of the modified audiovisual content can be output using a video output subsystem of the device.

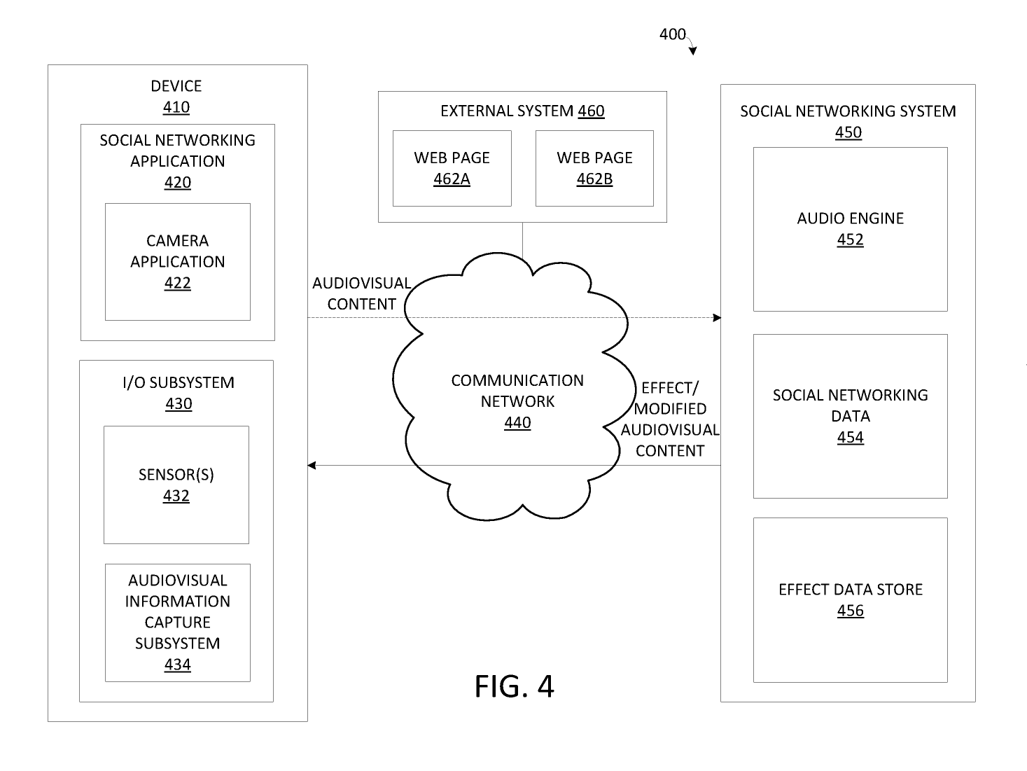

FIG. 4 is a simplified block diagram of a distributed environment 400 that may implement an exemplary embodiment. Distributed environment 400 may comprise multiple systems communicatively coupled to each other via one or more communication networks 440. Distributed environment 400 includes device 410 and social networking system 450. Distributed environment 400 depicted in FIG. 4 is merely an example and is not intended to unduly limit the scope of inventive embodiments recited in the claims. One of ordinary skill in the art would recognize many possible variations, alternatives, and modifications. For example, in some implementations, distributed environment 400 may have more or fewer systems than those shown in FIG. 4, may combine two or more systems, or may have a different configuration or arrangement of systems.

Distributed environment 400 can further include external system 460. External system 460 may include one or more web servers that each includes one or more web pages (e.g., web page 462a and webpage 462b) which may communicate with device 410 using communication network 440. External system 460 may be separate from social networking system 450. For example, external system 460 may be associated with a first domain, while social networking system 450 may be associated with a separate social networking domain. Web pages 462a, 462b, included in external system 460, may include markup language documents identifying content and including instructions specifying formatting or presentation of the identified content.

Communication network 440 facilitates communications between the various systems depicted in FIG. 4. Communication network 440 can be of various types and can include one or more communication networks. Examples of the communication network 340 include, without restriction, the Internet, a wide area network (WAN), a local area network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk®, Bluetooth®, and other protocols. In general, communication network 440 may include any infrastructure that facilitates communications between the various systems depicted in FIG. 4.

A user may use device 410 to interact with applications executed by device 410, such as social networking application 420. Device 410 can be a mobile device (e.g., an iPhone™ device, iPad™ device), a desktop computer, a laptop computer, or other computing device. Device 410 can include multiple subsystems, including input and/or output (I/O) subsystem 430.

I/O subsystem 430 may include components for inputting and/or outputting data to or from device 410. For example, I/O subsystem 430 can include a screen for displaying content on device 410. For another example, I/O subsystem 430 can include one or more sensors 432 for detecting features around the device and receiving interactions. Examples of sensors can include a Global Positioning System (GPS), accelerometer, keyboard, speaker, a thermometer, an altimeter, or other sensors that can provide live input to the device.

In some embodiments, a video output subsystem and an audio output subsystem can be included in I/O subsystem 430. The video output subsystem (not illustrated) can output one or more frames (e.g., an image or a video) from device 410. The audio output subsystem (not illustrated) can output audio from device 410.

In some embodiments, I/O subsystem 430 may include audiovisual information capture subsystem 434 for capturing audio and/or visual information. Audiovisual information capture subsystem 434 may include, for example, one or more cameras for capturing images or video information, one or more microphones for capturing audio information, or the like.

One or more applications may be installed on device 410 and may be executed by device 410, such as social networking application 420, which can include camera application 422. While FIG. 4 depicts only social networking application 420, this is not intended to be limiting, other applications may also be executed by device 410. Further, while camera application 422 is shown as part of social networking application 420 in FIG. 4, in some other embodiments, camera application 422 may be separate from social networking application 420 (e.g., a separate application executing on device 410).

In certain embodiments, camera application 422 can receive and output one or more images, a video, a video stream, and/or audio information captured by audio-visual information capture subsystem 434.

As described above, distributed environment 400 may include social networking system 450. In certain embodiments, social networking system 450 can act as a server-side component for social networking application 420 executed by device 410. For example, social networking system 450 can receive data from device 410, such as audiovisual content, sensor inputs, or other data from device 410. Similarly, social networking system 450 can send data to device 410, such as modified audiovisual data.

Social networking system 450 can include audio engine 452, social networking data 454, and effects data store 456. While FIG. 4 illustrates each of these components included in social networking system 450, it should be recognized that one or more of the components can be remote from social networking system 450. For example, effect data store 456 can be on a remote network and/or server as relative to social networking system 450.

Audio engine 452 can receive audiovisual content from device 410. Based on the audiovisual content (or data accompanying the audiovisual content), the audio engine can determine to modify the audiovisual content with one or more audio effects. In some embodiments, the one or more audio effects can be stored in effect data store 456. In other embodiments, at least a portion of the one or more audio effects can be stored on device 410 (or another device) and be sent to audio engine 452. In such embodiments, an audio effect can be sent to audio engine 452 with (or separately from) the audiovisual content.

In some examples, social networking system 450 might not receive audiovisual content from device 410. Instead, social networking system 450 may receive identification information of a user (e.g., user identifier (UID)). For example, when a user opens camera application 422, device 410 may send a UID for the user to social networking system 450. For another example, social networking system 450 may have already identified the user. In such an example, camera application 422 may send a message requesting an audio effect, without the UID. In some examples, in addition to an identification of the user, social networking system 450 can identify a location of device 410 (e.g., through information stored by social networking system 450 regarding device 410 and/or social networking application 420 or through data sent from social networking application 420, such as GPS data).

In one illustrative example, social networking system 450 can identify that a particular user is inside of a museum and provide an audio effect to camera application 422. The audio effect can then be received by device 410 and be applied to audiovisual content being presented by device 410. For example, the audiovisual content being presented by device 410 might not be stored by device 410, but rather be in camera mode where the audiovisual content is being received by device 410 from audiovisual information capture subsystem 434. In such an example, a user can cause a portion of a modified audiovisual content (audiovisual content that is modified based on the audio effect) to be stored by device 410.

Social networking system 450 can be associated with one or more computing devices for a social network, including a plurality of users, and providing users of the social network with the ability to communicate and interact with other users of the social network. In some instances, the social network can be represented by a graph (e.g., a data structure including edges and nodes). Other data structures can also be used to represent the social network, including but not limited to, databases, objects, classes, meta elements, files, or any other data structure. Social networking system 450 may be administered, managed, or controlled by an operator. The operator of the social networking system 450 may be a human being, an automated application, or a series of applications for managing content, regulating policies, and collecting usage metrics within social networking system 450. Any type of operator may be used.

Users may join social networking system 450 and then add connections to any number of other users of social networking system 450 to whom they desire to be connected. As used herein, the term “friend” refers to any other user of social networking system 450 to whom a user has formed a connection, association, or relationship via social networking system 450. For example, in an embodiment, if users in social networking system 450 are represented as nodes in the social graph, the term “friend” can refer to an edge formed between and directly connecting two user nodes.

Connections may be added explicitly by a user or may be automatically created by social networking system 450 based on common characteristics of the users (e.g., users who are alumni of the same educational institution). For example, a first user specifically selects a particular other user to be a friend. Connections in social networking system 450 are usually in both directions, but need not be, so the terms “user” and “friend” depend on the frame of reference. Connections between users of social networking system 450 are usually bilateral (“two-way”), or “mutual,” but connections may also be unilateral, or “one-way.” For example, if Bob and Joe are both users of social networking system 450 and connected to each other, Bob and Joe are each other's connections. If, on the other hand, Bob wishes to connect to Joe to view data communicated to social networking system 450 by Joe, but Joe does not wish to form a mutual connection, a unilateral connection may be established. The connection between users may be a direct connection; however, some embodiments of social networking system 450 allow the connection to be indirect via one or more levels of connections or degrees of separation.

In addition to establishing and maintaining connections between users and allowing interactions between users, social networking system 450 provides users with the ability to take actions on various types of items supported by social networking system 450. These items may include groups or networks (e.g., social networks of people, entities, and concepts) to which users of social networking system 450 may belong, events or calendar entries in which a user might be interested, computer-based applications that a user may use via social networking system 450, transactions that allow users to buy or sell items via services provided by or through social networking system 450, and interactions with advertisements that a user may perform on or off social networking system 450. These are just a few examples of the items upon which a user may act on social networking system 450, and many others are possible. A user may interact with anything that is capable of being represented in social networking system 450 or in external system 460, separate from social networking system 450, or coupled to social networking system 450 via communication network 440.

Social networking system 450 is also capable of linking a variety of entities. For example, social networking system 450 enables users to interact with each other as well as external systems or other entities through an API, a web service, or other communication channels. Social networking system 450 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in social networking system 450. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, social networking system 450 modifies edges connecting the various nodes to reflect the relationships and interactions.

Social networking system 450 also includes user-generated content, which enhances a user's interactions with social networking system 450. User-generated content may include anything a user can add, upload, send, or “post” to social networking system 450. For example, a user communicates posts to social networking system 450 from device 410. Posts may include data such as status updates or other textual data, location information, images such as photos, videos, links, music or other similar data and/or media. Content may also be added to social networking system 450 by a third party. Content “items” are represented as objects in social networking system 450. In this way, users of social networking system 450 are encouraged to communicate with each other by posting text and content items of various types of media through various communication channels. Such communication increases the interaction of users with each other and increases the frequency with which users interact with social networking system 450.

Social networking system 450 can include a web server, an API request server, a user profile store, a connection store, an action logger, an activity log, an authorization server, or any combination thereof. In some embodiments, social networking system 450 may include additional, fewer, or different components for various applications. Other components, such as network interfaces, security mechanisms, load balancers, failover servers, management and network operations consoles, and the like are not shown so as to not obscure the details of the system.

The user profile store, which can be included in social networking data 454, can maintain information about user accounts, including biographic, demographic, and other types of descriptive information, such as work experience, educational history, hobbies or preferences, location, and the like that has been declared by users or inferred by social networking system 450. This information is stored in the user profile store such that each user is uniquely identified. Social networking system 450 also stores data describing one or more connections between different users in the connection store. The connection information may indicate users who have similar or common work experience, group memberships, hobbies, or educational history. Additionally, social networking system 450 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in social networking system 450, such as non-person entities, buckets, cluster centers, images, interests, pages, external systems, concepts, and the like are also stored in the connection store.

Social networking system 450 maintains data about objects with which a user may interact. To maintain this data, the user profile store and the connection store may store instances of the corresponding type of objects maintained by social networking system 450. Each object type has information fields that are suitable for storing information appropriate to the type of object. For example, the user profile store contains data structures with fields suitable for describing a user's account and information related to a user's account. When a new object of a particular type is created, social networking system 450 initializes a new data structure of the corresponding type, assigns a unique object identifier to it, and begins to add data to the object as needed. This might occur, for example, when a user becomes a user of social networking system 450, social networking system 450 generates a new instance of a user profile in the user profile store, assigns a unique identifier to the user account, and begins to populate the fields of the user account with information provided by the user.

The connection store includes data structures suitable for describing a user's connections to other users, connections to external systems or connections to other entities. The connection store may also associate a connection type with a user's connections, which may be used in conjunction with the user's privacy setting to regulate access to information about the user. In an embodiment, the user profile store and the connection store may be implemented as a federated database.

Data stored in the connection store, the user profile store, and the activity log enables social networking system 450 to generate the social graph that uses nodes to identify various objects and edges connecting nodes to identify relationships between different objects. For example, if a first user establishes a connection with a second user in social networking system 450, user accounts of the first user and the second user from the user profile store may act as nodes in the social graph. The connection between the first user and the second user stored by the connection store is an edge between the nodes associated with the first user and the second user. Continuing this example, the second user may then send the first user a message within social networking system 450. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by social networking system 450 (or, alternatively, in an image maintained by another system outside of social networking system 450). The image may itself be represented as a node in social networking system 450. This tagging action may create edges between the first user and the second user as well as create an edge between each of the users and the image, which is also a node in the social graph. In yet another example, if a user confirms attending an event, the user and the event are nodes obtained from the user profile store, where the attendance of the event is an edge between the nodes that may be retrieved from the activity log. By generating and maintaining the social graph, social networking system 450 includes data describing many different types of objects and the interactions and connections among those objects, providing a rich source of socially relevant information.

The web server links social networking system 450 to one or more user devices (e.g., device 410) and/or one or more external systems (e.g., external system 460) via communication network 440. The web server serves web pages, as well as other web-related content, such as Java, JavaScript, Flash, XML, and so forth. The web server may include a mail server or other messaging functionality for receiving and routing messages between social networking system 450 and one or more user devices (e.g., device 410). The messages can be instant messages, queued messages (e.g., email), text and SMS messages, or any other suitable messaging format.

The API request server allows one or more external systems and user devices to call access information from social networking system 450 by calling one or more API functions. The API request server may also allow external systems to send information to social networking system 450 by calling APIs. External system 460, in one embodiment, sends an API request to social networking system 450 via communication network 440, and the API request server receives the API request. The API request server processes the request by calling an API associated with the API request to generate an appropriate response, which the API request server communicates to the external system 460 via communication network 440. For example, responsive to an API request, the API request server collects data associated with a user, such as the user's connections that have logged into external system 460, and communicates the collected data to external system 460. In another embodiment, the device 410 communicates with social networking system 450 via APIs in the same manner as external system 460.

The action logger is capable of receiving communications from the web server about user actions on and/or off social networking system 450. The action logger populates the activity log with information about user actions, enabling social networking system 450 to discover various actions taken by its users within social networking system 450 and outside of social networking system 450. Any action that a particular user takes with respect to another node on social networking system 450 may be associated with each user's account, through information maintained in the activity log or in a similar database or other data repository. Examples of actions taken by a user within social networking system 450 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within social networking system 450, the action is recorded in the activity log. In one embodiment, social networking system 450 maintains the activity log as a database of entries. When an action is taken within social networking system 450, an entry for the action is added to the activity log. The activity log may be referred to as an action log.

Additionally, user actions may be associated with concepts and actions that occur within an entity outside of social networking system 450, such as external system 460 that is separate from social networking system 450. For example, the action logger may receive data describing a user's interaction with external system 460 from the web server. In this example, the external system 460 reports a user's interaction according to structured actions and objects in the social graph.

Other examples of actions where a user interacts with external system 460 include a user expressing an interest in external system 460 or another entity, a user posting a comment to social networking system 450 that discusses external system 460 or a web page 462a within external system 460, a user posting to social networking system 450 a Uniform Resource Locator (URL) or other identifier associated with external system 460, a user attending an event associated with external system 460, or any other action by a user that is related to external system 460. Thus, the activity log may include actions describing interactions between a user of social networking system 450 and external system 460 that is separate from social networking system 450.

The authorization server enforces one or more privacy settings of the users of social networking system 450. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems. One embodiment allows the specification of the set of entities to comprise an enumeration of entities. For example, the user may provide a list of external systems that are allowed to access certain information. Another embodiment allows the specification to comprise a set of entities along with exceptions that are not allowed to access the information. For example, a user may allow all external systems to access the user's work information, but specify a list of external systems that are not allowed to access the work information. Certain embodiments call the list of exceptions that are not allowed to access certain information a “block list.” External systems belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server contains logic to determine if certain information associated with a user can be accessed by a user's friends, external systems, and/or other applications and entities. External system 460 may need authorization from the authorization server to access the user's more private and sensitive information, such as the user's work phone number. Based on the user's privacy settings, the authorization server determines if another user, external system 460, an application, or another entity is allowed to access information associated with the user, including information about actions taken by the user.

For purposes of illustration, distributed environment 400 includes a single external system 460 and a single device 410. However, in other embodiments, distributed environment 400 may include more user devices 410 and/or more external systems 460. In certain embodiments, social networking system 450 is operated by a social network provider, whereas external system 460 is separate from social networking system 450 in that they may be operated by different entities. In various embodiments, however, social networking system 450 and external system 460 operate in conjunction to provide social networking services to users (or members) of social networking system 450. In this sense, social networking system 450 provides a platform or backbone, which other systems, such as external system 460, may use to provide social networking services and functionalities to users across communication network 440.

FIG. 4 depicts a distributed environment that may be used to implement certain embodiments. However, this is not intended to be limiting. In some alternative embodiments, all the processing described above may be performed by a single system. For example, in certain embodiments, the processing may be performed entirely on user device 410, or entirely on social networking system 450.

### EXAMPLES

This section describes various examples of audio effects that may be determined by an audio engine (e.g., the audio engine 220) and applied to audiovisual content. These examples are not intended to be in any manner limiting.

### Example #1

### Related to a Friend's Birthday

A social networking application associated with a user can display that it is a birthday of the user's friend. The friend may not be associated with the device, but rather a different user than the user. In response to the user opening a camera application associated with the social networking application, the camera application can send a message to an audio engine on a social networking system. The message can include an indication of the user. The audio engine, using the indication of the user, can identify that it is the friend's birthday using a social graph of the user. The audio engine can then send an audio effect that includes the Happy Birthday song to a device of the user so that the user can use the audio effect to send modified audiovisual content to the friend for the friend's birthday. The device can either provide an indication of the availability of the audio effect or can automatically start applying the audio effect, which would cause the Happy Birthday song to begin playing.

### Example #2

### A User's Anniversary

When the user opens a camera application associated with a social networking application, the camera application can send a message to an audio engine on a social networking system. The message can include audiovisual content being obtained by a camera of a device of the user. In some cases, the message can further include an indication that it is the user's anniversary. In other cases, a user profile for the user can indicate that it is the user's anniversary. The audio engine can identify the user's anniversary song based on a post that the user made on their profile. The post can be included in a social graph for the user. The audio engine can then obtain an audio effect that includes the user's anniversary song. The audio engine can further determine to play the user's anniversary song after the user says “Happy Anniversary.” Accordingly, the audio engine can send an audio effect with the user's anniversary song and a starting requirement that the words “Happy Anniversary” are said. When the words “Happy Anniversary” are identified, the device can modify audiovisual content of the device by adding the user's anniversary song in the background.

### Example #3

### A Birthday of a User

An audio engine of a social networking system can identify a year that the user was born. Based on the year, the audio engine can identify multiple audio effects to add to audiovisual content the next time that the user opens a camera application on a device of the user. An audio effect of the multiple effects can include changing a pitch of the user's voice to a low voice. Another audio effect can be triggered when the low voice is activated, making sounds of airplanes be played in the background. And a final audio effect can reduce the volume of the sound of the airplanes to make them sound like they are far away. The multiple audio effects can then be sent to the device with a starting requirement that the camera application is opened.

### Example #4

### Content Recognition

An audio engine can identify a user in audiovisual content using face recognition. Based on the identification of the user, the audio engine can obtain an audio effect that includes the song “Kung Fu Fighting” by Carl Douglas when it is identified that a kick occurs in audiovisual content. A device of the user can continue to send audiovisual content to the audio engine until the audio engine identifies that a kick occurs using a content recognition system. When the audio engine identified that a kick occurs, the audio engine can send a message to the device to have the audio effect applied to audiovisual content on the device. In other cases, the content recognition system can be located on the device such that audiovisual content does not need to be repeatedly sent to the audio engine. The audio effect of the song can be added to audiovisual content on the device when a kick is identified.

Data Privacy

Some embodiments described herein make use of social networking data that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well.

Computing System

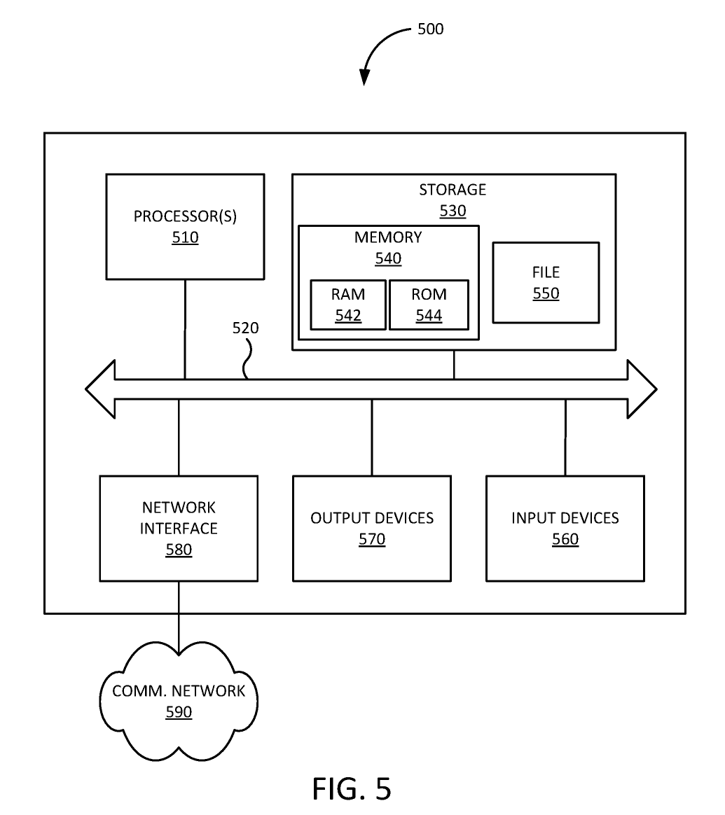

FIG. 5 illustrates an example of a block diagram of a computing system. The computing system shown in FIG. 5 can be used to implement device 410, social networking system 450, or any other computing device described herein. In this example, computing system 500 includes monitor 510, computer 420, keyboard 430, user input device 540, one or more computer interfaces 550, and the like. In the present example, user input device 540 is typically embodied as a computer mouse, a trackball, a track pad, a joystick, wireless remote, drawing tablet, voice command system, eye tracking system, and the like. User input device 540 typically allows a user to select objects, icons, text and the like that appear on monitor 510 via a command such as a click of a button or the like.

Examples of computer interfaces 450 typically include an Ethernet card, a modem (telephone, satellite, cable, ISDN), (asynchronous) digital subscriber line (DSL) unit, FireWire interface, USB interface, and the like. For example, computer interfaces 550 may be coupled to computer network 555, to a FireWire bus, or the like. In other embodiments, computer interfaces 550 may be physically integrated on the motherboard of computer 520, may be a software program, such as soft DSL, or the like.

In various examples, computer 520 typically includes familiar computer components such as processor 560, and memory storage devices, such as random access memory (RAM) 470, disk drives 580, and system bus 590 interconnecting the above components.

RAM 570 and disk drive 580 are examples of tangible media configured to store data such as embodiments of the present disclosure, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In various examples, computing system 500 may also include software that enables communications over a network such as the HTTP, TCP/IP, RTP/RTSP protocols, and the like. In alternative embodiments of the present disclosure, other communications software and transfer protocols may also be used, for example IPX, UDP or the like.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method comprising:
identifying, by a computing system, a user of a social networking system;
accessing, by the computing system, data stored by the social networking system, wherein the data is associated with the user;
selecting, by the computing system, an audio effect based on the data stored by the social networking system, wherein the audio effect indicates how to modify an audio portion of audiovisual content; and
sending, by the computing system:
the audio effect to a device for modifying audiovisual content on the device; or
modified audiovisual content to the device, wherein the modified audiovisual content comprises an audio portion modified based on the audio effect.

2. The method of claim 1, wherein the audio effect includes an ambient sound to be added to the audiovisual content, an indication of an event to cause an audio portion to be added to the audiovisual content, one or more algorithms to synthesize sound, a location to be used to balance sound for spatialized audio, or one or more parameters for applying one or more digital signal processor (DSP) techniques to the audiovisual content.

3. The method of claim 1, wherein the data stored by the social networking system includes data describing the user or data related to connections between the users of the social networking system, and wherein the users of the social networking system includes the user.

4. The method of claim 1, wherein modifying the audiovisual content on the device includes merging the audio effect with the audiovisual content on the device.

5. The method of claim 1, wherein the modified audiovisual content is output by the device.

6. The method of claim 5, wherein:
an audio portion of the modified audiovisual content is output using an audio output subsystem of the device; and
a video portion of the modified audiovisual content is output using a video output subsystem of the device.

7. The method of claim 1, wherein the user is associated with the device.

8. The method of claim 1, wherein:
the user is a first user, and
a second user is associated with the device.

9. The method of claim 1 further comprising:
receiving, at the computing system, audiovisual content associated with the user; and
determining, by the computing system, an attribute of the received audiovisual content, wherein determining the audio effect is further based on the attribute.

10. The method of claim 9, wherein the user is identified based on the received audiovisual content.

11. The method of claim 9, wherein the user is identified by detecting a presence of the user in the received audiovisual content.

12. The method of claim 1 further comprising:
receiving, at the computing system, sensor data from one or more sensors of the device, wherein determining the audio effect is further based on the sensor data.

13. The method of claim 12, wherein the sensor data includes data indicative of a physical location of the device.

14. The method of claim 12, wherein the sensor data includes accelerometer data generated by an accelerometer of the device or a temperature reading sensed by a temperature sensor on the device.

15. A non-transitory computer-readable storage medium storing a plurality of instructions executable by one or more processors, the plurality of instructions when executed by the one or more processor cause the one or more processors to:
identify, by a computing system, a user of a social networking system;
access, by the computing system, data stored by the social networking system, wherein the data is associated with the user;
select, by the computing system, an audio effect based on the data stored by the social networking system, wherein the audio effect indicates how to modify an audio portion of audiovisual content; and
send, by the computing system:
the audio effect to a device for modifying audiovisual content on the device; or
modified audiovisual content to the device, wherein the modified audiovisual content comprises an audio portion modified based on the audio effect.

16. The non-transitory computer-readable storage medium of claim 15, wherein the plurality of instructions when executed by the one or more processor further cause the one or more processors to:
receive, at the computing system, audiovisual content associated with the user; and
determine, by the computing system, an attribute of the received audiovisual content, wherein determining the audio effect is further based on the attribute.

17. The non-transitory computer-readable storage medium of claim 15, wherein the plurality of instructions when executed by the one or more processor further cause the one or more processors to:
receive, at the computing system, sensor data from one or more sensors of the device, wherein determining the audio effect is further based on the sensor data.

18. A system comprising:
one or more processors; and
a non-transitory computer-readable medium including instructions that, when executed by the one or more processors, cause the one or more processors to perform operations including:
identify a user of a social networking system;
access data stored by the social networking system, wherein the data is associated with the user;
select an audio effect based on the data stored by the social networking system, wherein the audio effect indicates how to modify an audio portion of audiovisual content; and
send:
the audio effect to a device for modifying audiovisual content on the device; or
modified audiovisual content to the device, wherein the modified audiovisual content comprises an audio portion modified based on the audio effect.

19. The system of claim 18, wherein the instructions further cause the one or more processors to perform operations including:
receive audiovisual content associated with the user; and
determine an attribute of the received audiovisual content, wherein determining the audio effect is further based on the attribute.

20. The system of claim 18, wherein the instructions further cause the one or more processors to perform operations including:
receive sensor data from one or more sensors of the device, wherein determining the audio effect is further based on the sensor data.
